(19) United States
(12) Patent Application Publication
(10) Pub. No.: US 2014/0317586 A1
(43) Pub. Date: Oct. 23, 2014

(54) SUPPORT DEVICE, DESIGN SUPPORT METHOD, AND COMPUTER-READABLE RECORDING MEDIUM

(71) Applicant: FUJITSU LIMITED, Kawasaki-shi (JP)

(72) Inventors: Sumiko Makino, Toyohashi (JP); Yasuo Amano, Nukata (JP); Masashi Arayama, Gamagori (JP)

(73) Assignee: FUJITSU LIMITED, Kawasaki-shi (JP)

(21) Appl. No.: 14/253,248

(22) Filed: Apr. 15, 2014

(30) Foreign Application Priority Data
Apr. 19, 2013 (JP) 2013-088831

(51) Int. Cl. G06F 17/50

(52) U.S. Cl. CPC G06F 17/5072; G06F 2217/84
USPC 716/122

(57) ABSTRACT

A design support device includes placement determination unit, logic extraction unit, and logic placement unit. The placement determination unit performs the process of determining the optimum position of a first terminal of a first cell as a first position in which the inter-terminal wiring between the first cell and a second cell connected to the first cell through the first terminal is short. Furthermore, the logic placement unit performs the process of extracting one or more logical blocks including a logical block having the first terminal from the first cell, and arranging one or more logical blocks so that the first terminal may become close to the first position.

### CROSS-REFERENCE TO RELATED APPLICATION

This application is based upon and claims the benefit of priority of the prior Japanese Patent Application No. 2013-088831, filed on Apr. 19, 2013, the entire contents of which are incorporated herein by reference.

### FIELD

The embodiments discussed herein are related to the technology of designing an integrated circuit.

### BACKGROUND

Recently, the circuit scale of an integrated circuit has increased year after year to satisfy the requests for high functionality and high performance of an integrated circuit. In response to the requests, a designing method for generating several types of standard cells implemented with the functions requested by a user, and storing the generated cells in a library in advance has been put to practical use. In this case, when an integrated circuit is designed, a user instructs an information processing device to extract a standard cell having a requested function from a library. Then, the information processing device places the extracted standard cell in the integrated circuit as illustrated in FIG. 24, thereby configuring the circuit. Thus, the designing period of a circuit is shortened. In the following explanation, the standard cell is referred to also as a reference cell.

As a related technology, a layout method for a semiconductor circuit by a standard cell system using an placing and wiring program transforms a cell layout according to the information provided from the placing and wiring program. Then, the placing and wiring program detects the position in which the wiring length to each cell is shortest and the number of crossings is the smallest after provisional placement and wiring operations. Furthermore, there is a technology known as an placing and wiring program which provides the result of the detection for the cell library, and performs the placing and wiring operation again (for example, Japanese Laid-open Patent Publication No. 3-29341).

### SUMMARY

The design support device disclosed in the present specification includes a processor. The processor performs the process of determining the optimum position of a first terminal of a first cell as a first position in which the inter-terminal wiring between the first cell and a second cell connected to the first cell through the first terminal is short. Furthermore, the processor performs the process of extracting one or more logical blocks including a logical block having the first terminal from the first cell, and placing one or more logical blocks so that the first terminal may approach the first position.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of the functions and illustrates an embodiment of a design support device;

FIG. 2 is a flowchart of the placement process in a cell;

FIG. 3 is a flowchart of the process of determining the optimum terminal position of a cell;

FIG. 4 is a flowchart of the process of generating a connection rule;

FIG. 5 is a flowchart of the process of placing a logical block;

FIG. 6 is a flowchart of the process of placing a logical block;

FIG. 7 is a flowchart of the unit evaluation process of a logical block;

FIG. 8 is a flowchart of the process of evaluating a cell;

FIG. 9 is a block diagram of an embodiment of a computer device;

FIG. 10 is an example of the placement position information about cells;

FIG. 11 is an example of the connection rule information about cells;

FIG. 12 is an example of the direction in which a cell terminal is connected;

FIG. 13 is an example of the optimum terminal position of a cell terminal;

FIG. 14 is an example of the optimum terminal position of a cell terminal;

FIG. 15 is an example of mesh segmentation of a cell;

FIG. 16 is an example of a logical block;

FIG. 17 is an example of a connection of logical blocks;

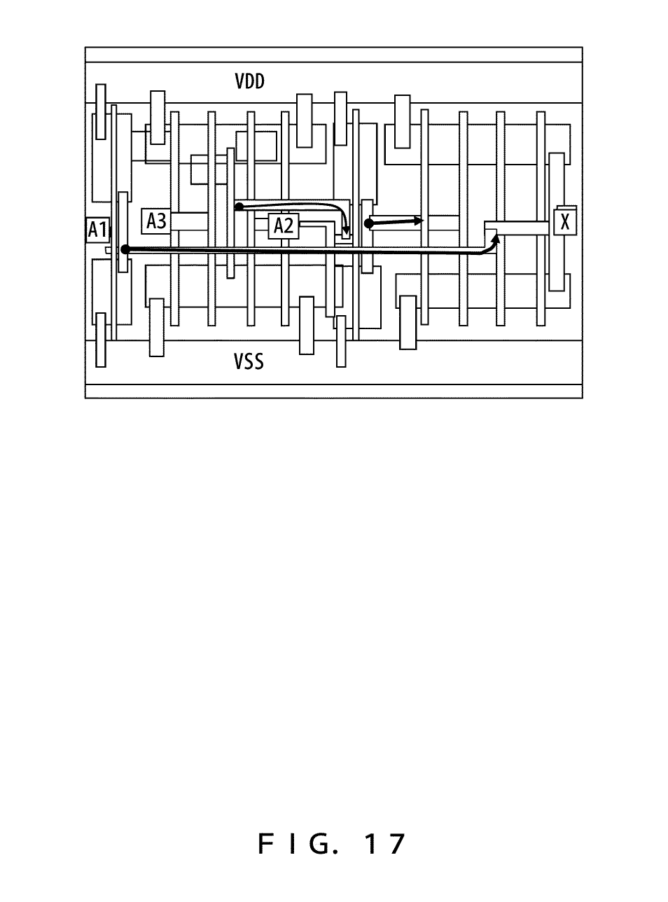

FIG. 18 is an example of recognizing a connection;

FIG. 19 is an example of recognizing a connection;

FIG. 20 is an example of data of connection rule information;

FIG. 21A is an example of an placement of a logical block;

FIG. 21B is an example of an placement of a logical block;

FIG. 21C is an example of an placement of a logical block;

FIG. 22A is an example of an integrated circuit using a reference cell;

FIG. 22B is an example of an integrated circuit using a reference cell;

FIG. 23A is an example of an integrated circuit using an placed cell;

FIG. 23B is an example of an integrated circuit using an placed cell;

FIG. 24 is an embodiment of a cell placed on an integrated circuit; and

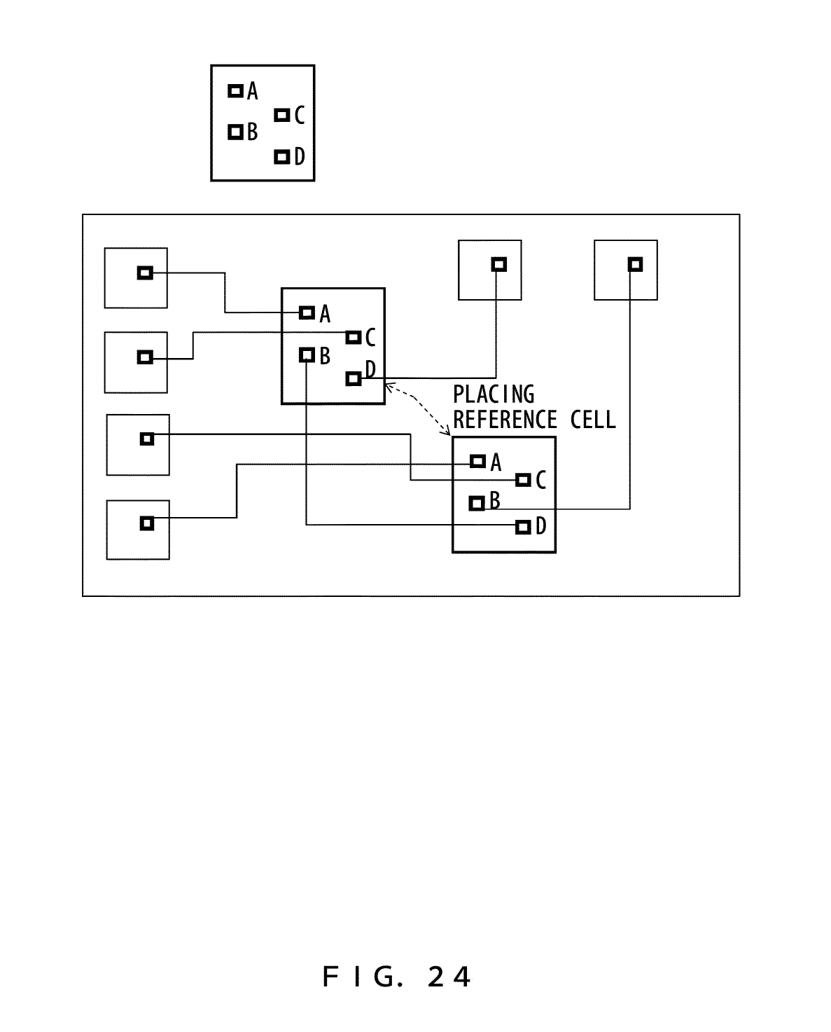

FIG. 25 is an embodiment of wiring for a cell.

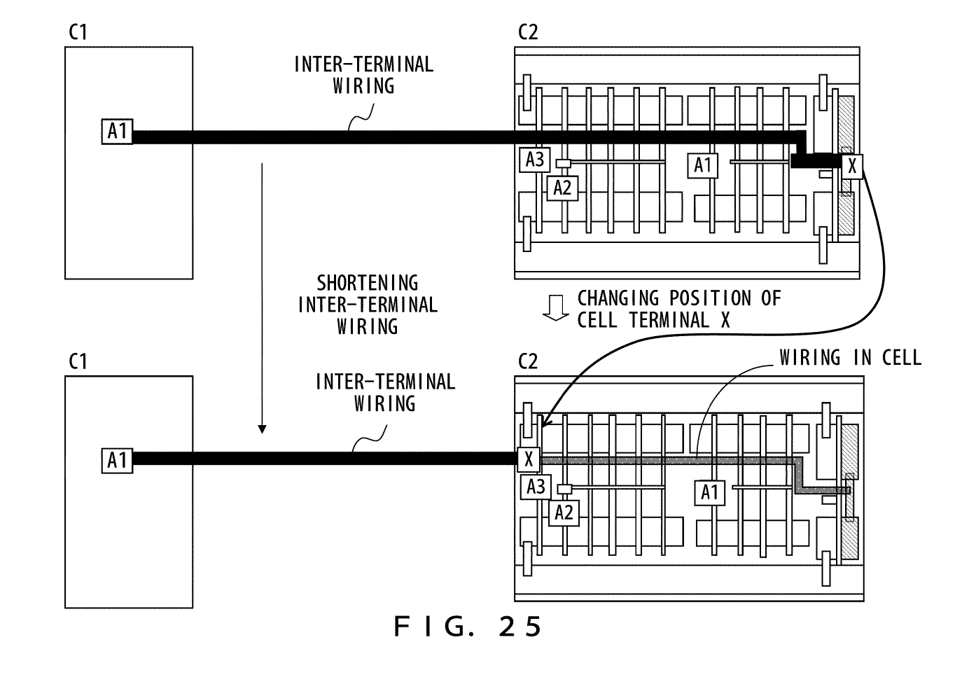

### DESCRIPTION OF EMBODIMENTS

Described below is a design support device of an embodiment of the present invention.

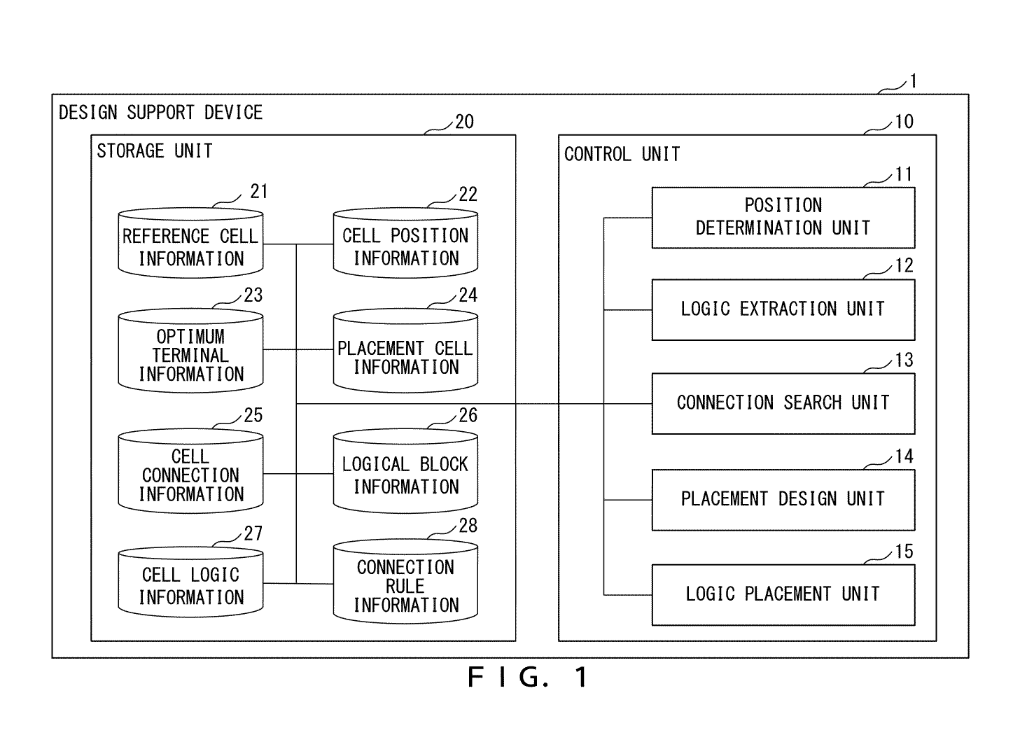

FIG. 1 is a block diagram of the functions and illustrates an embodiment of a design support device.

The design support device is described below with reference to FIG. 1. In the following explanation, what is simply described as a cell refers to a reference cell, a placed cell, or a target cell.

A design support device 1 includes a control unit 10 and a storage unit 20. The design support device 1 is, for example, a computer device described later.

The control unit 10 has the functions or a position determination unit 11, a logic extraction unit 12, a connection search unit 13, a placement design unit 14, and a logic placement unit 15.

The position determination unit 11 determines the optimum position of the first terminal of the first cell as the first position in which the inter-terminal wiring between the first cell and the second cell connected to the first cell through the first terminal becomes short. The first cell is a target cell in which a logical block in a reference cell described later is replaced. The second cell is a cell to which a connection is made from a target cell described later. The inter-terminal wiring is performed from a cell terminal of the first cell to a cell terminal of the second cell. The cell terminal electrically connects cells by inter-terminal wiring. The first position is, for example, the optimum placement position of a cell terminal described later.

The position determination unit 11 determines the first position so that, when there are a plurality of cells to which a connection is made of the first terminal, the influence of a signal output from the first terminal may be equal in timing with which the signal is input to the plurality of cells to which a connection is made.

When the first cell has a second terminal connected to a third cell, the position determination unit 11 determines the optimum position of the second terminal as the second position in which the wiring length between the first cell and the third cell becomes short. The third cell refers to a cell to which a connection is made from the target cell described later. The second position refers to the optimum placement position of a cell terminal described later.

The logic extraction unit 12 extracts from the first cell one or more logical blocks including a logical block having the first terminal. The logic extraction unit 12 also extracts an area in which the diffusion layers of the first cell continue, and defines the area as one or more logical blocks. The logical block refers to a circuit block which configures a logic in a cell.

When the logic extraction unit extracts from the first cell two or more logical blocks, the connection search unit 13 retrieves two or more mutually connected logical blocks from two or more logical blocks.

The placement design unit 14 sets the placement order of each of two or more connected logical blocks so that the output destination of each connected logical block on the output side may refer to the same direction in the two or more connected logical blocks. The placement order is, for example, a connection rule described later.

The logic placement unit 15 places one or more logical blocks so that the first terminal may approach the first position. When the logic placement unit 15 places each of two or more logical blocks, it defines the placement of two or more connected logical blocks as a placement order set by the placement design unit, and places each of the two or more logical blocks so that the first terminal may approach the first position. When the first cell is provided with the second terminal, the logic placement unit 15 places each of one or more logical blocks so that the second terminal may approach the second position determined by the position determination unit 11.

The logic placement unit 15 obtains the distance between the first terminal and the first position each time the placement of one or more logical blocks is changed, and places one or more logical blocks for the placement in which the distance may be the shortest. When the first cell is provided with the second terminal, the logic placement unit 15 obtains the sum of the distance between the first terminal and the first position and the distance between the second terminal and the second position each time the placement of one or more logical blocks is changed, and places one or more logical blocks in an placement having the smallest sum. The distance between the first terminal and the first position refers to, for example, a terminal evaluation value described later. The sum of the distance between the first terminal and the first position and the distance between the second terminal and the second position refers to, for example, a cell evaluation value described later. When there is one cell terminal in the first cell, the distance between the first terminal and the first position refers to, for example, a cell evaluation value described later.

The logic placement unit 15 stores in the storage unit 20 the placement of one or more logical blocks of the first cell. Then, the logic placement unit 15 judges whether or not there is the third cell which is the same type as the first cell and has the optimum position of the terminal connected to another cell set in the position corresponding to the first position. When there is the third cell, the logic placement unit 15 places one or more logical blocks of the third cell as the same array as one or more logical blocks of the first cell. The third cell refers to a target cell described later. When the placement of the logical block of the first cell is stored in the storage unit 20, the logic placement unit 15 stores the placement in placement cell information 24.

The storage unit 20 includes a reference cell information 21, a cell position information 22, an optimum terminal information 23, an placement cell information 24, a cell connection information 25, a logical block information 26, a cell logic information 27, and a connection rule information 28.

The reference cell information 21 stores circuit information about a reference cell implemented with a function requested by a user. Then, the reference cell information 21 may also be stored with, for example, the logic of a reference cell associated with the implementation of a reference. The circuit information about a reference cell may include, for example, the placement information about the transistor in a reference cell and a diffusion layer and the wiring information for connection of each transistor in the reference cell. Furthermore, the wiring information for connection of a transistor may include the coordinate information indicating the connection point between transistors. The circuit information about a reference cell may also include the coordinate information about the placement position of a cell terminal of a reference cell.

The cell position information 22 stores the placement position information about a cell placed in the integrated circuit input by a user when the integrated circuit is generated. The cell position information 22 may also store the placement position information obtained as a result of, for example, selecting by the design support device 1 a cell implemented for the integrated circuit from the reference cell information 21 according to the information about the function of an integrated circuit input by a user to the design support system 1, and placing the implemented cell on the integrated circuit. Then, the cell position information 22 may also store, for example, the type of each placed cell associated with the coordinate information about the placement of each cell for each integrated circuit.

The optimum terminal information 23 stores the optimum placement position information about each cell terminal of a cell for each cell of the integrated circuit stored in the cell position information 22. The optimum placement position of a cell terminal refers to the coordinate information about the placement position of a cell terminal set so that the inter-terminal wiring of a cell placed on an integrated circuit may be shorter. In the following explanation, the optimum placement position of a cell terminal is also referred to as the optimum position of a cell terminal.

The placement cell information 24 stores the placed cell information indicating the placement order of a logical block of the placed cells obtained by replacing the logical block of a reference cell by the logic placement unit 15. The placement cell information 24 may also store the terminal position information indicating the terminal position of a cell terminal of each placed cell. The placement cell information 24 also store the type of each placed cell, the placement order of a logical block, and the terminal position information about a cell terminal which are associated with one another. The type of an placed cell may, for example, be identified by the type of reference cell based on which the placed cell is determined.

The cell connection information 25 stores the connection information between cells placed in the integrated circuit. The connection information between cells may include, for example, the information indicating cells connected each other in a plurality of cells placed in an integrated circuit, and the connection information between cell terminals of respective cells. The cell connection information 25 is, for example, a net list.

The logical block information 26 stores the identification information about one or more logical blocks of each cell extracted by the logic extraction unit 12. The logical block information 26 may store, for example, the information identifying each logical block of each cell associated with the logic of each logical block. The logical block information 26 may also store a logical block having a cell terminal associated with the coordinate information about the placement position of the cell terminal in a logical block. The logical block information 26 may store the wiring information about a transistor in a logical block which realizes the logic of the logical block.

The cell logic information 27 stores, for example, the logical information included in a cell. The cell logic information 27 stores the connection information about each logic of a cell for realization of the logic of the cell.

The cell logic information 27 may store the connection information between logical blocks for realization of the logic of a cell. The connection information between the logical blocks refers to the information indicating the connection point between the gate of the first transistor of the first logical block and the source of the second transistor.

The connection rule information 28 stores the placement order of each logical block in the cell set by the placement design unit 14 according to the connection information about the logical block of the cell logic information 27. In the following explanation, the placement order of each logical block in the cell set by the placement design unit 14 is also referred to as a connection rule. A setting of a connection rule by the placement design unit 14 is described later.

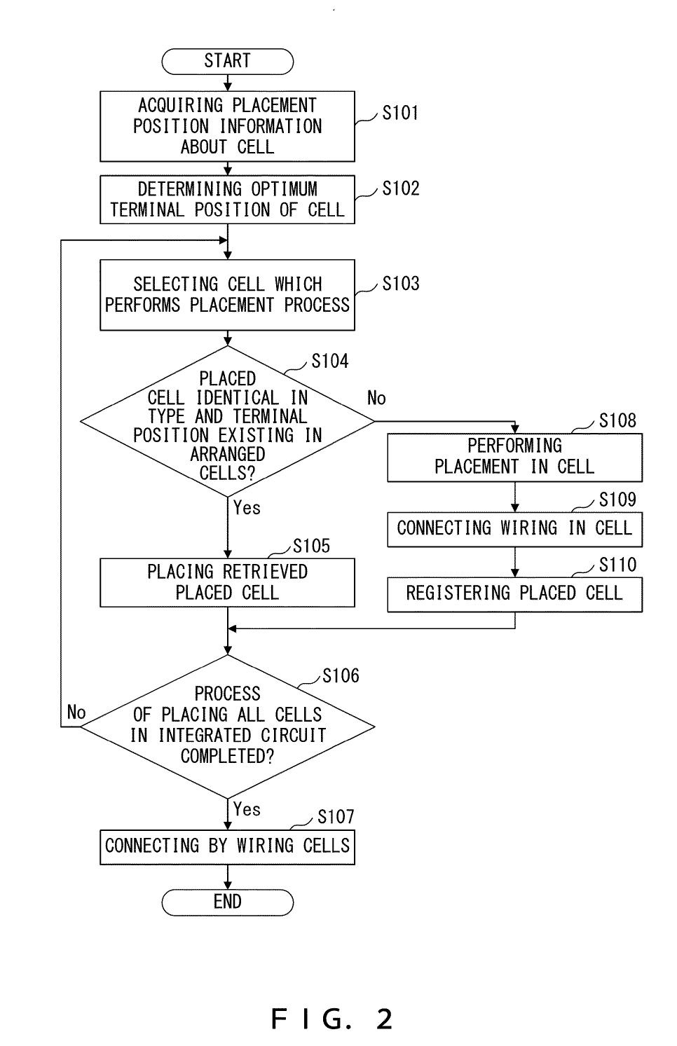

FIG. 2 is a flowchart of the placement process in a cell.

The placing process in a cell by the design support device 1 according to an embodiment of the present invention is described below with reference to FIG. 2. In the explanation below, it is assumed that a user inputs in the design support device 1 in advance the placement position information about a cell placed in an integrated circuit, and the placement position information is stored in the cell position information 22.

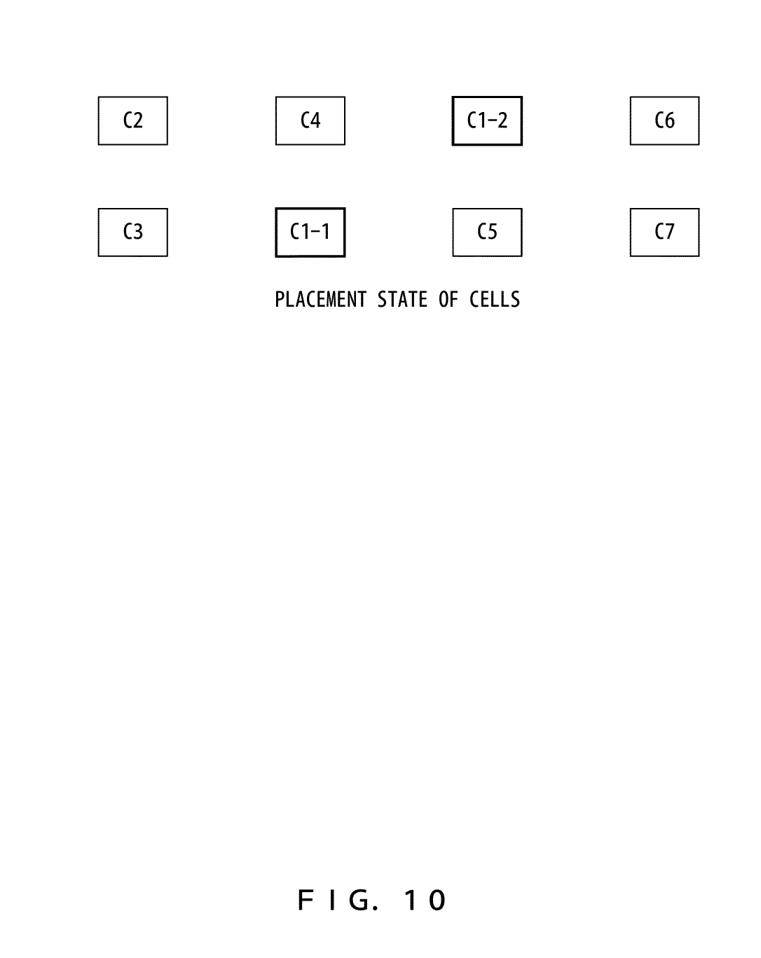

The position determination unit 11 acquires the placement position information about a cell from the cell position information 22 (S101). In this case, it is assumed that the placement position information about a cell includes the placement state of the cell illustrated in FIG. 10. In FIG. 10, C1-1 and C1-2 through C7 refer to the cells placed in an integrated circuit. C1-1 and C1-2 indicate the cell of the same reference cell C1.

The position determination unit 11 determines the optimum terminal position of each cell placed in the integrated circuit indicated by the placement position information about a cell (S102).

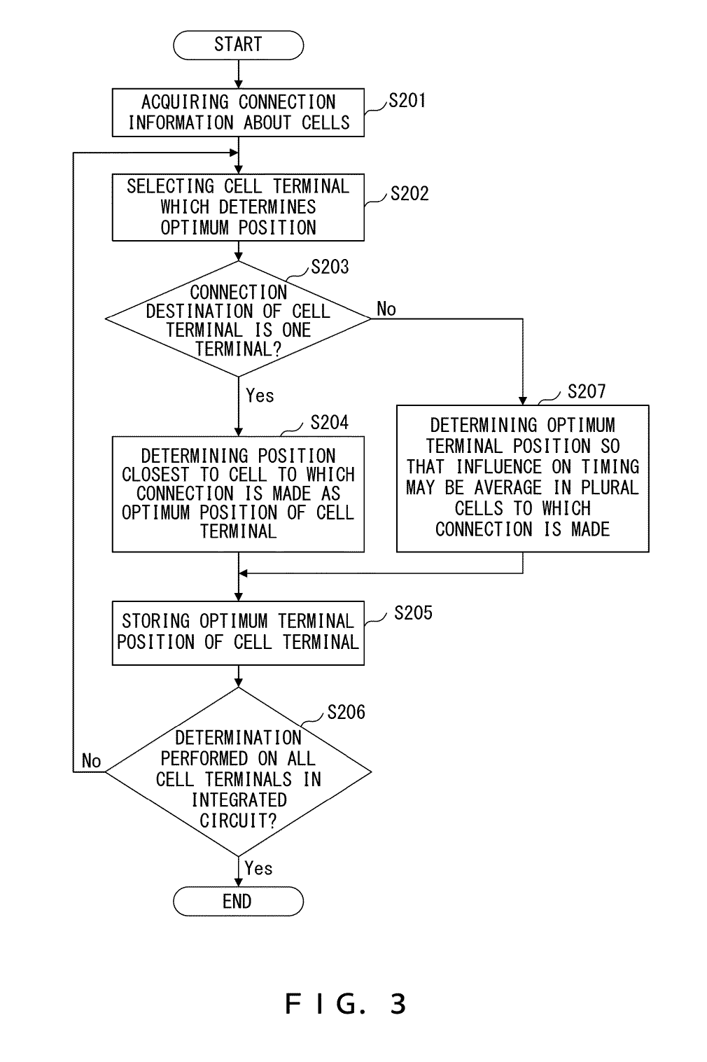

The process of determining the optimum terminal position of a cell in S102 is described below with reference to FIG. 3.

FIG. 3 is a flowchart of the process of determining the optimum terminal position of a cell.

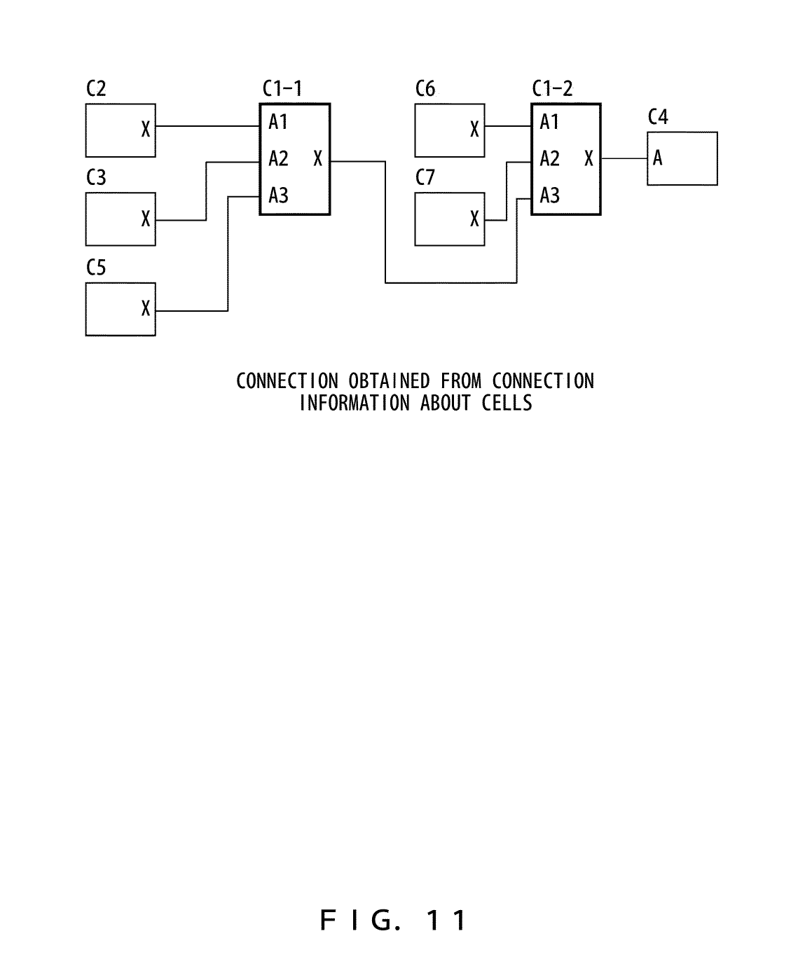

The position determination unit 11 acquires from the cell connection information 25 the connection information between cells (S201). In this case, it is assumed that the connection information between the cells includes the placement position information about the cell in FIG. 11.

Then, the position determination unit 11 refers to the information about the cell terminal of each cell included in the acquired connection information between the cells, and selects the cell terminal for determination of the optimum position (S202). In the second and subsequent S202, the position determination unit 11 may select an unselected cell terminal.

The position determination unit 11 refers to the connection information between cells, and judges whether or not there is one cell terminal to which the connection is made from the cell terminal selected in S202 (S203).

When there is one cell terminal to which a connection is made in S203, the position determination unit 11 determines the placement area closest to the cell to which a connection is made as the optimum terminal position of the selected cell terminal (S204).

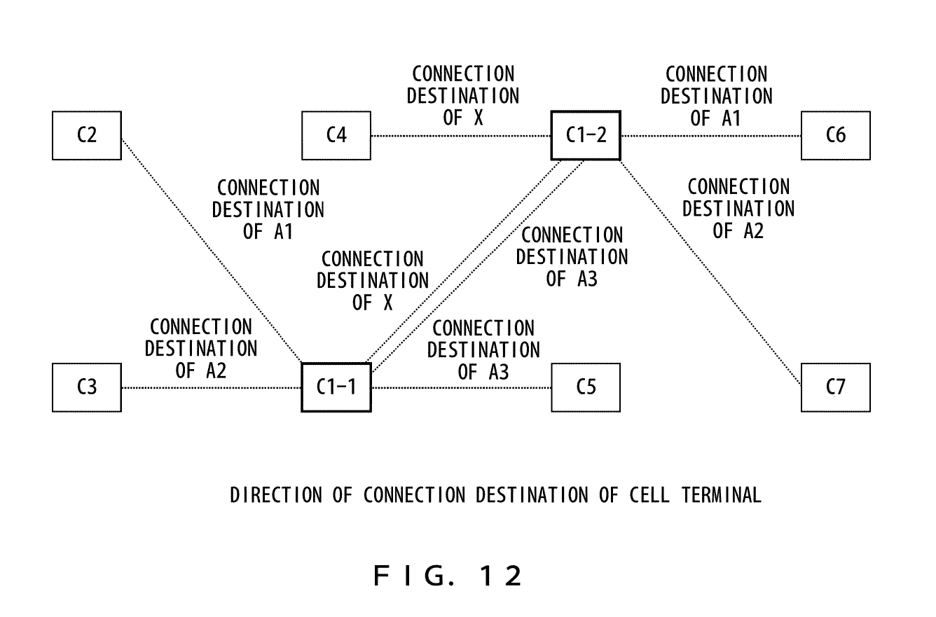

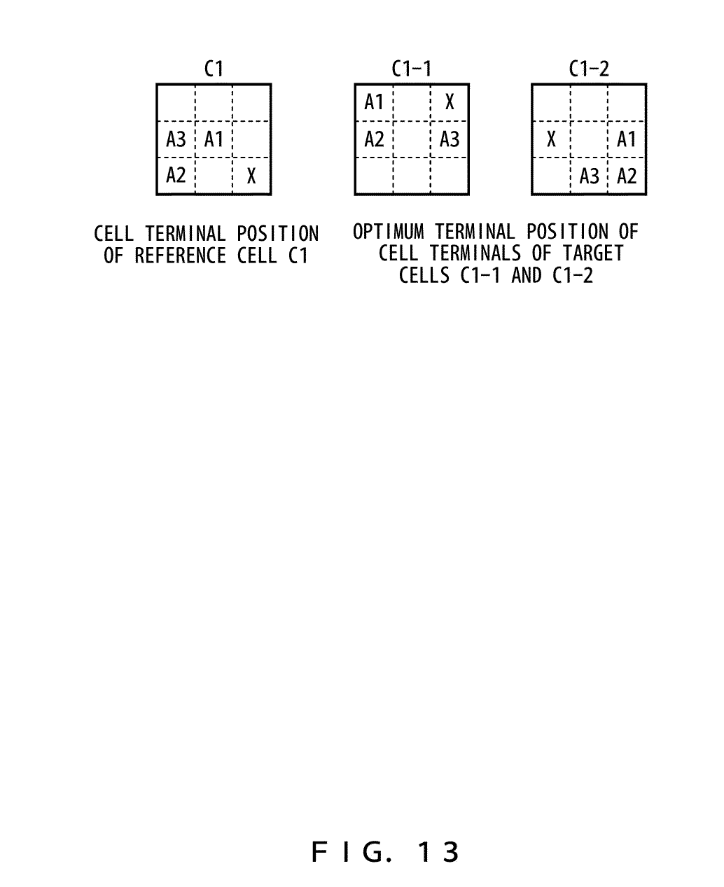

In this case, the position determination unit 11 judges the direction of the connection of the cell terminal of each cell placed in the integrated circuit according to the placement position information about a cell and the connection information between cells as illustrated in FIG. 12. FIG. 12 illustrates as an example the direction of the connection of the cell terminals of C1-1 and C1-2. Then, as illustrated in FIG. 13, the position determination unit 11 determines the placement area closest to the cell to which a connection is made as the optimum terminal position of each cell terminal of a target cell depending on the direction of the connection of a cell terminal. The target cell refers to a cell in which a logical block is to be replaced. As indicated by the broken lines in FIG. 13, the placement area may be each area of a cell segmented by the position determination unit 11. Then, the position determination unit 11 specifies the optimum terminal position of a cell terminal of a cell, it may specify an placement area. The larger the cell size is, the larger number of placement areas the position determination unit 11 may obtain by segmenting a cell area.

The position determination unit 11 determines, for example, the optimum terminal position of a cell terminal having one cell terminal to which a connection is made. The target cell C1-1 is, for example, the same in type as the reference cell C1. The target cell C1-1 has the same cell terminal as the reference cell C1. Then, as illustrated in FIG. 12, in the target cell C1-1, the cell terminal A1 is electrically connected to the cell C2 at the position diagonally above to the left on the integrated circuit. Therefore, in the target cell C1-1, as illustrated in FIG. 13, the optimum terminal position of the cell terminal A1 is determined as the placement area diagonally above to the left. The position determination unit 11 similarly determines the optimum terminal positions of other cell terminal A2, cell terminal A3, and cell terminal X of the target cell C1-1. In addition, the position determination unit 11 similarly determines the optimum terminal position of the cell terminal of another cell.

Then, when the position determination unit 11 determines the optimum terminal position of a cell terminal, it stores the determined optimum terminal position of the cell terminal in the optimum terminal information 23 (S205).

The position determination unit 11 judges whether or not the optimum terminal position has been determined on all cell terminals in the integrated circuit (S206). When the position determination unit 11 determines the optimum terminal position on all cell terminals in the integrated circuit (YES in S206), it terminates the process of determining the optimum terminal position of a cell.

When there is a cell terminal on which the optimum terminal position has not been determined in all cell terminals in the integrated circuit (NO in S206), the process in S202 is performed.

In S203, the position determination unit 11 determines the optimum terminal position of a selected cell terminal so that the influence on the timing of inputting a signal output from the selected cell terminal to a plurality of cells to which a connection is made may be averaged among a plurality of cells to which a connection is made (S207). Then, the position determination unit 11 performs the process in S205.

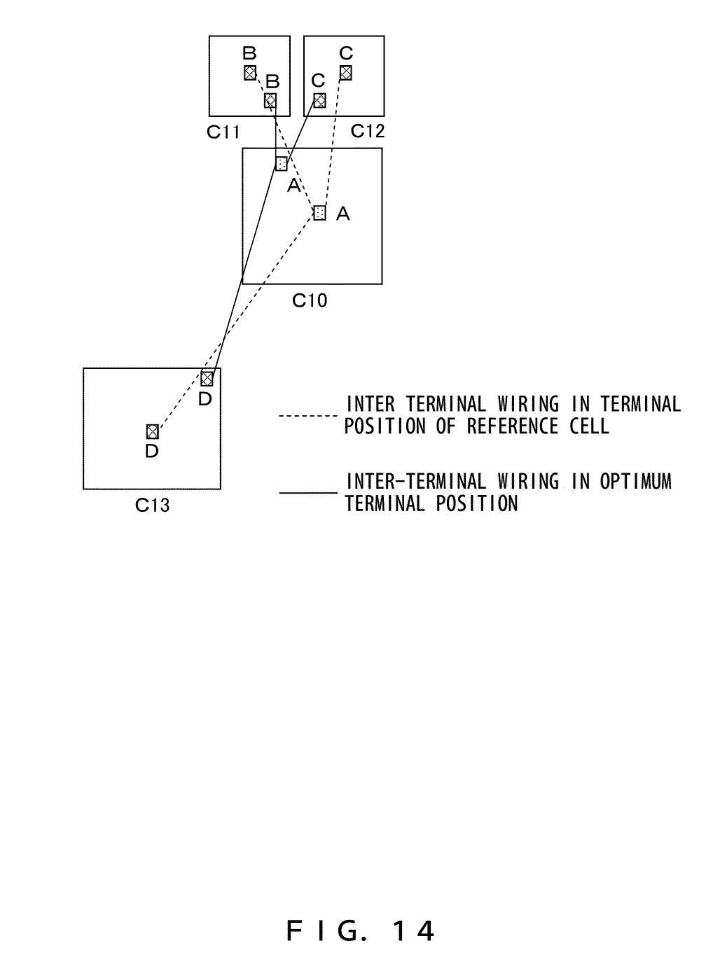

In S207, the position determination unit 11 may consider the input load of a cell to which a connection is made, the wiring length (wiring capacity, wiring resistance) from the cell to which a connection is made, the restrictive time such as a set up time, a hold time, a clock rising time, etc. The position determination unit 11 may further determine the optimum terminal position of a cell terminal so that the entire influence of the timing on the signal input to the plurality of cells to which a connection is made from a cell terminal may be not higher than the level before the change of the position of the cell terminal. The averaged influence on the timing among a plurality of cells to which a connection is made refers to, for example, the timing margin for a correct read of a signal input from a selected cell terminal by a cell to which a connection is made is averaged. Thus, as illustrated in FIG. 14 for example, the position determination unit 11 sets the optimum terminal position of the cell terminal A of the target cell C10 at the position diagonally above to the left from the terminal position of the reference cell C10. In FIG. 14, the inter-terminal wiring AD in the optimum terminal position is set longer than the inter-terminal wiring AB and the inter-terminal wiring AC because the timing margin of the cell C13 is longer than the cell C11 and the cell C12. That is, although the inter-terminal wiring AD of the cell C13 is longer than the inter-terminal wiring AB and the inter-terminal wiring AC, the cell may acquire the same level of timing margin. Therefore, the reduction of the influence on the timing of the cell C11 and the cell C12 is prioritized.

In S207, the position determination unit 11 further may determine the optimum terminal position of the selected cell terminal so that the delay of the communication time of a signal may be minimized between the selected cell terminal and each of a plurality of cells to which a connection is made. The communication time refers to, for example, the reach time of a signal communicated between the selected cell terminal and a cell to which a connection is made.

As described above, the position determination unit 11 determines the optimum terminal position of the cell terminal of the cell placed in the integrated circuit.

The determination is described below with reference to FIG. 2.

In S102, when the optimum terminal position of a cell terminal is determined, the logic placement unit 15 selects a cell to be placed from among the cells placed in the integrated circuit with reference to the cell position information 22 (S103). In the following explanation, the cell selected in S103 is also referred to as a target cell. In the second and subsequent S103, the logic placement unit 15 may, for example, select an unselected cell as a target cell.

The logic placement unit 15 refers to the placement cell information 24, and searches whether or not there is an placed cell which is the same in type of reference cell as the target cell, and whose cell terminal is placed at the position indicated by the optimum terminal position of each cell of the target cell (S104). The logic placement unit 15 acquires, for example, the type of target cell from the cell position information 22. The logic placement unit 15 also acquires the optimum terminal position information about the target cell from the optimum terminal information 23.

In S104, when an placed cell corresponding to the target cell is stored in the placement cell information 24 (YES in S104), the logic placement unit 15 places the retrieved corresponding placed cell in the integrated circuit (S105). In S105, if the target cell is the same in type as the reference cell, and the influence on the timing is within an allowance range, then the logic placement unit 15 may place the placed cell which is different in the optimum terminal position of each cell terminal of the target cell in the integrated circuit.

Then, the logic placement unit 15 judges whether or not the placing process in the cell has terminated on all cells placed in the integrated circuit (S106).

When the placing process in the cell terminates on all cells placed in the integrated circuit (YES in S106), the logic placement unit 15 refers to the cell connection information 25, and connects by wiring the cells placed in the integrated circuit (S107). Then, the logic placement unit 15 terminates the placing process in the cell.

When there is a cell in which the placing process has not been completed in the cell among the cells placed in the integrated circuit (NO in S106), the logic placement unit 15 performs the process in S103.

In S104, when there is no placed cell corresponding to the target cell in the placement cell information 24, the logic placement unit 15 replaces the target cell (S108).

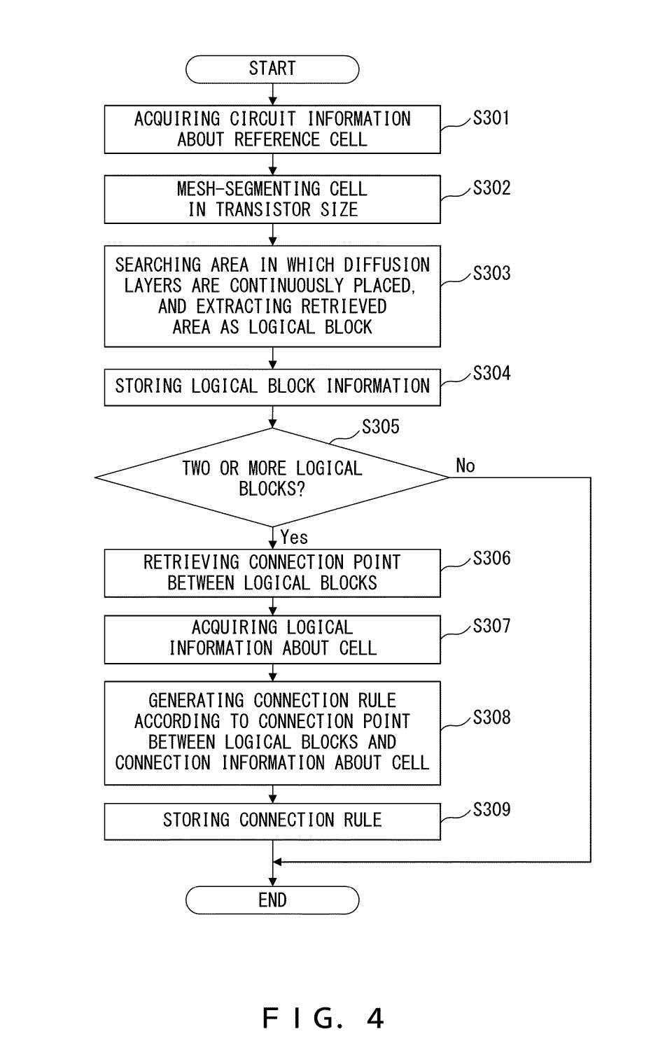

the replacing process in a cell to be performed in S108 is described below with reference to FIGS. 4 through 8.

FIG. 4 is a flowchart of the process of generating a connection rule.

The process of generating a connection rule is described below with reference to FIG. 4.

The logic extraction unit 12 acquires the circuit information about a reference cell corresponding to a target cell from the reference cell information 21 to extract a logical block as an placement unit in the target cell (S301).

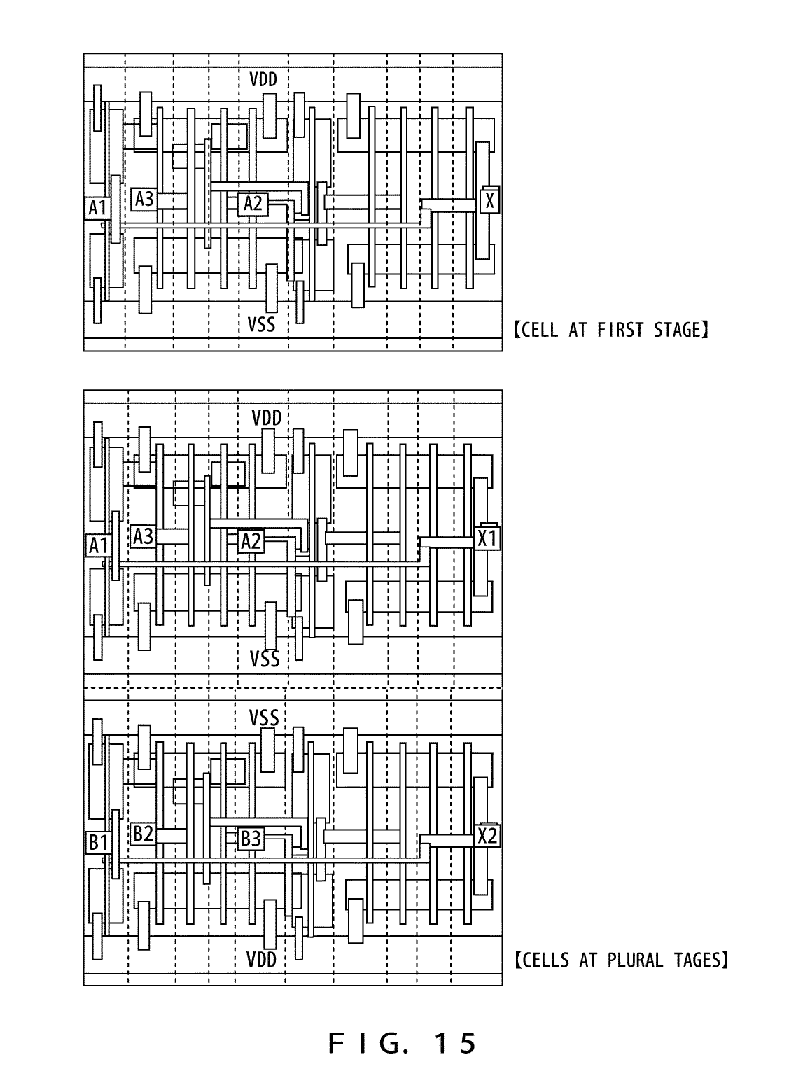

Then, as illustrated in FIG. 15, the logic extraction unit 12 performs mesh segmentation on a cell in transistor size (S302). In the following explanation, the area obtained by performing the mesh segmentation on a cell in transistor size is also referred to as a segmented area. The logic placement unit 15 defines the segmented area as a reference of the position in which a logical block in a cell is placed.

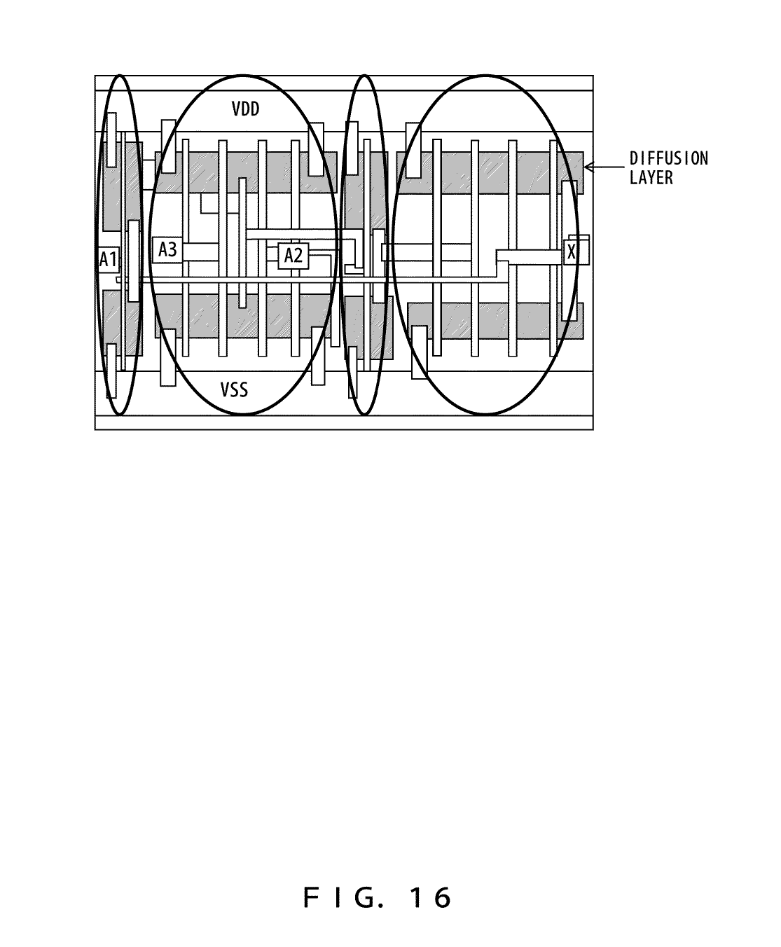

The logic extraction unit 12 refers to the circuit information about a reference cell, and judges for each segmented area whether or not diffusion layers connected to a power supply is continuously placed, thereby searching the range of a segmented area in which diffusion layers are continuously placed. Then, the logic extraction unit 12 extracts the retrieved area (each oval portion in FIG. 16) in which the diffusion layers are continuously placed as illustrated in FIG. 16 as a logical block (S303). That is, the logic extraction unit 12 retrieves a group of transistors whose sources and drains are continuously located, and extracts the group of the retrieved transistors as a logical block. The logical block is processed as an placement unit in a cell. Thus, when the circuit in a cell is replaced, the logic placement unit 15 maintains the connection in a logical block, thereby replacing the circuit of the cell without changing the entire logic or losing the logic.

Then, the logic extraction unit 12 stores one or more extracted logical blocks in the logical block information 26 (S304). In this case, the logic extraction unit 12 may store in the logical block information 26 the logical block including a cell terminal with the placement position of the cell terminal in the logical block.

Next, the connection search unit 13 refers to the logical block information 26, and judges whether or not there are two or more logical blocks extracted in S303 (S305). The connection search unit 13 terminates the process of generating a connection rule when there is one extracted logical block (NO in S305).

When there are two or more extracted logical block (YES in S305), the connection search unit 13 refers to the circuit information about the reference cell stored in the reference cell information 21, and searches for mutually connected logical blocks (connected logical blocks). Furthermore, the connection search unit 13 searches for the coordinate information about a connection point between the mutually connected logical blocks which have been retrieved (S306).

Furthermore, the placement design unit 14 refers to the cell logic information 27, and acquires the logical information about a cell (S307).

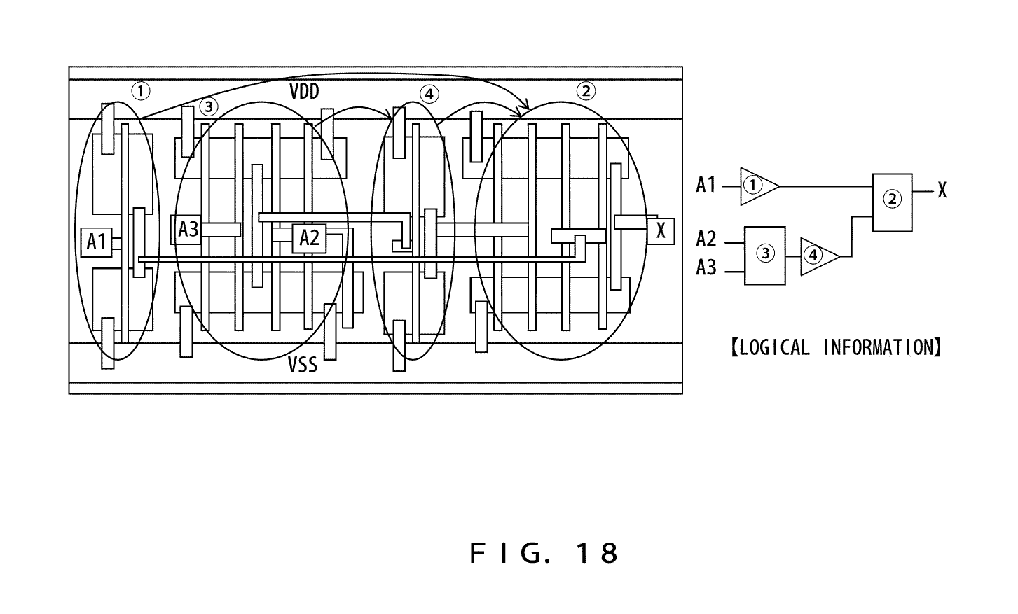

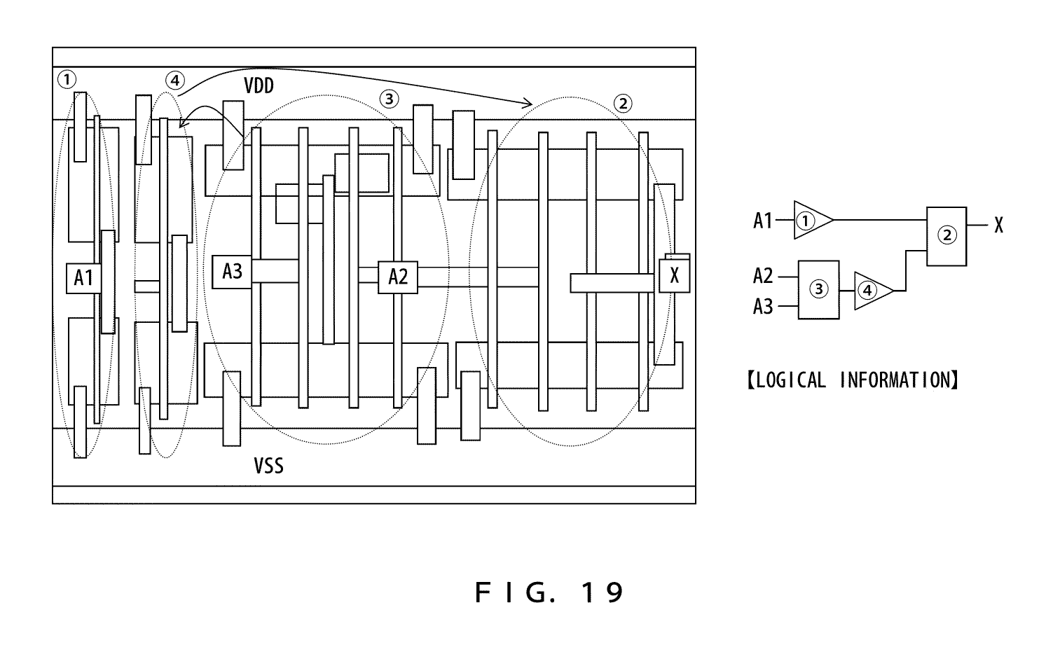

The placement design unit 14 generates the connection rule indicating the placement order of logical blocks to prevent the bypass of the wiring in a cell depending on the connection point between the logical blocks mutually connected and retrieved in S305, and the logical information about the cell acquired in S306 (S308). FIG. 18 illustrates the correspondence between the logics 1 through 4 indicated by the logical information about a cell and the logical blocks 1 through 4. As illustrated in FIG. 18, the connection rule is generated so that all signals from the logical block on the output side toward the logical block on the input side may be transmitted physically in the same direction. When a target cell has one cell terminal, the same direction refers to the direction toward the optimum terminal position. Therefore, generated is no rule in which, as illustrated in FIG. 19, the direction of the transmission of a signal output from the logical block 3 to the logical block 4 is different from the direction of the transmission of a signal output from the logical block 4 to the logical block 2. Thus, the placement design unit 14 generates a connection rule to prevent the bypass of the wiring in a cell.

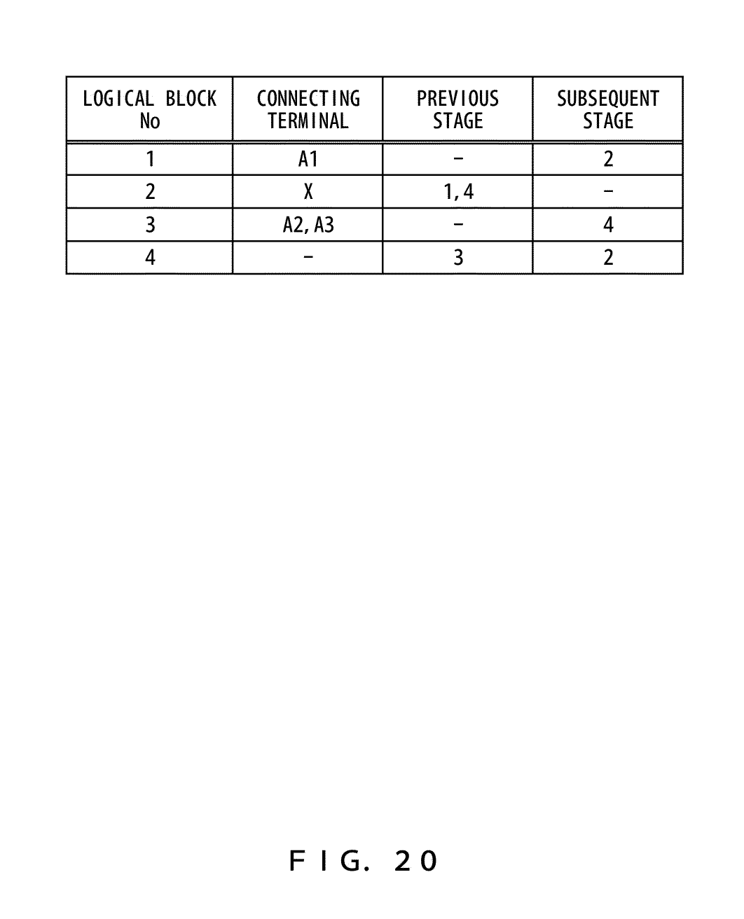

The placement design unit 14 stores the generated connection rule in the connection rule information 28 (S309). In this case, the connection rule information 28 stores, for example, as illustrated in FIG. 20, the identification information about each logical block of a cell associated with the connecting terminal of each logical block. Furthermore, the connection rule information 28 stores, for example, as illustrated in FIG. 20, the identification information about each logical block of a cell associated with the logical block connected to the previous stage and the logical block connected to the subsequent stage.

As described above, the design support device 1 generates a connection rule to avoid the bypass of the wiring in a cell.

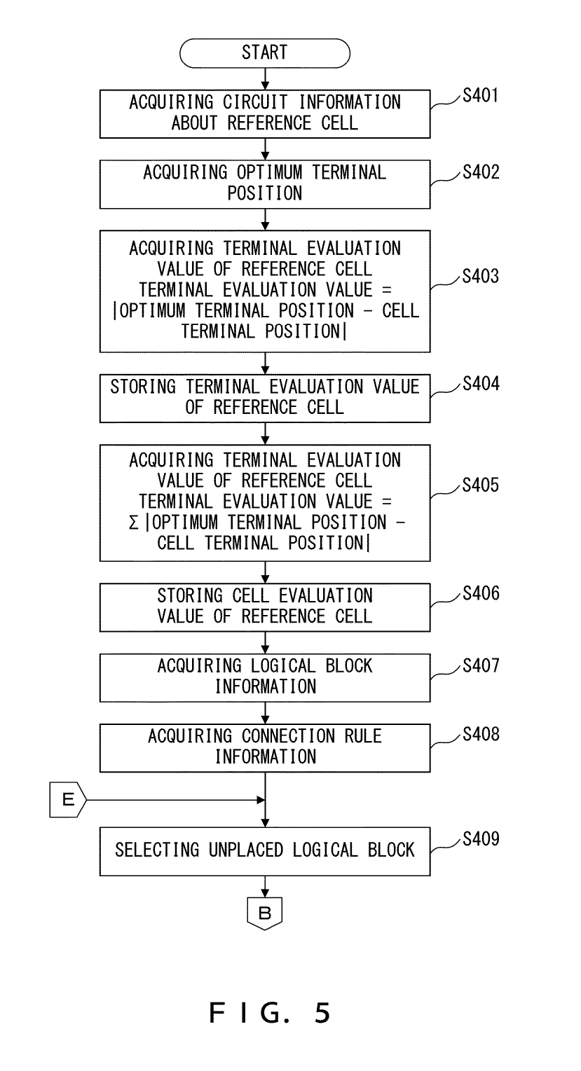

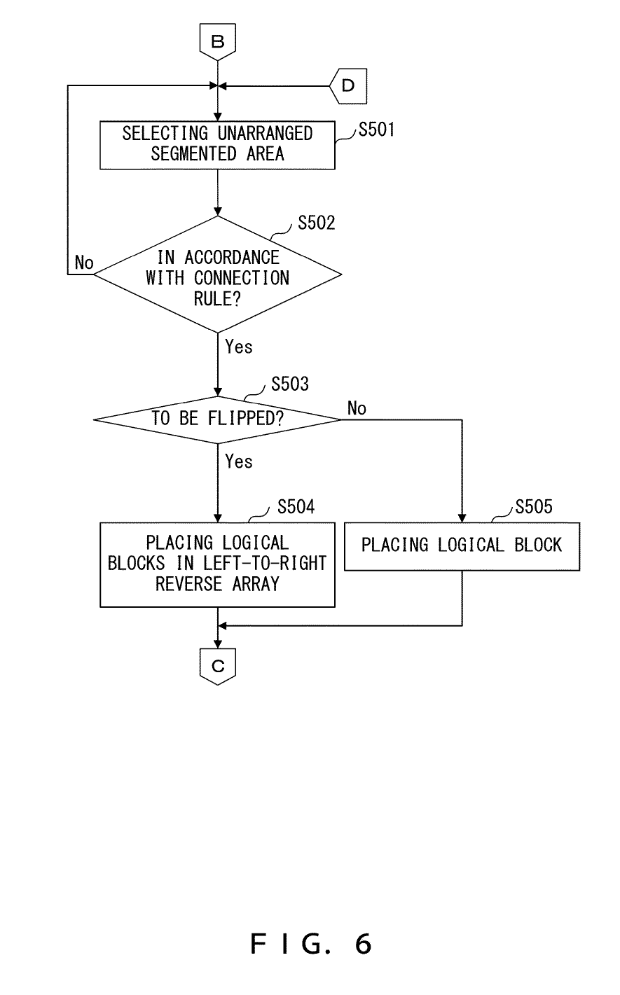

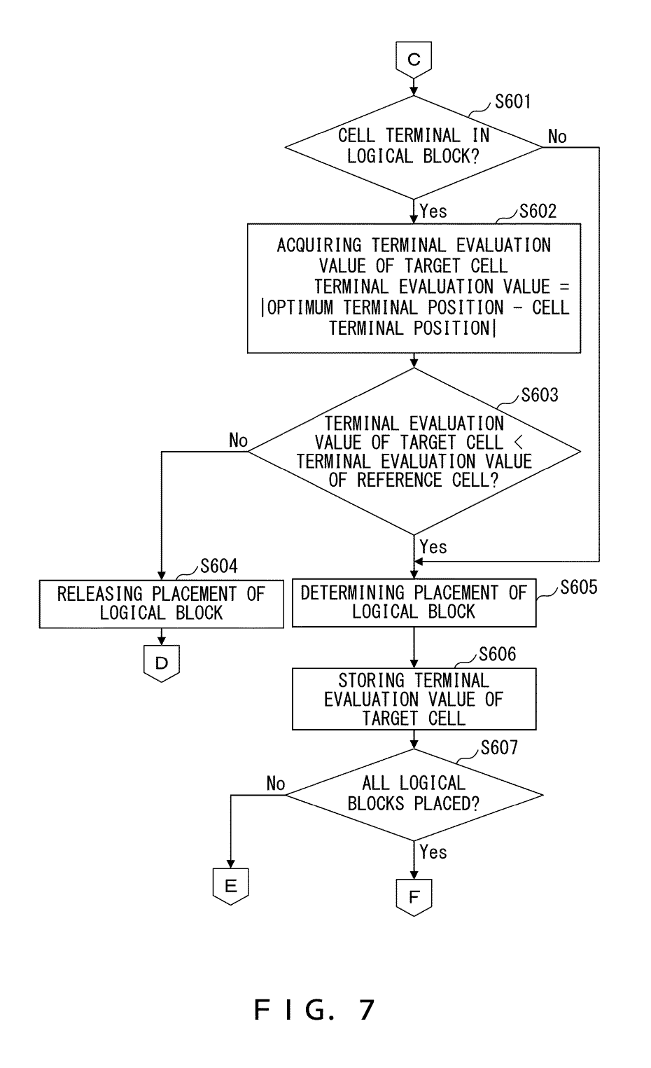

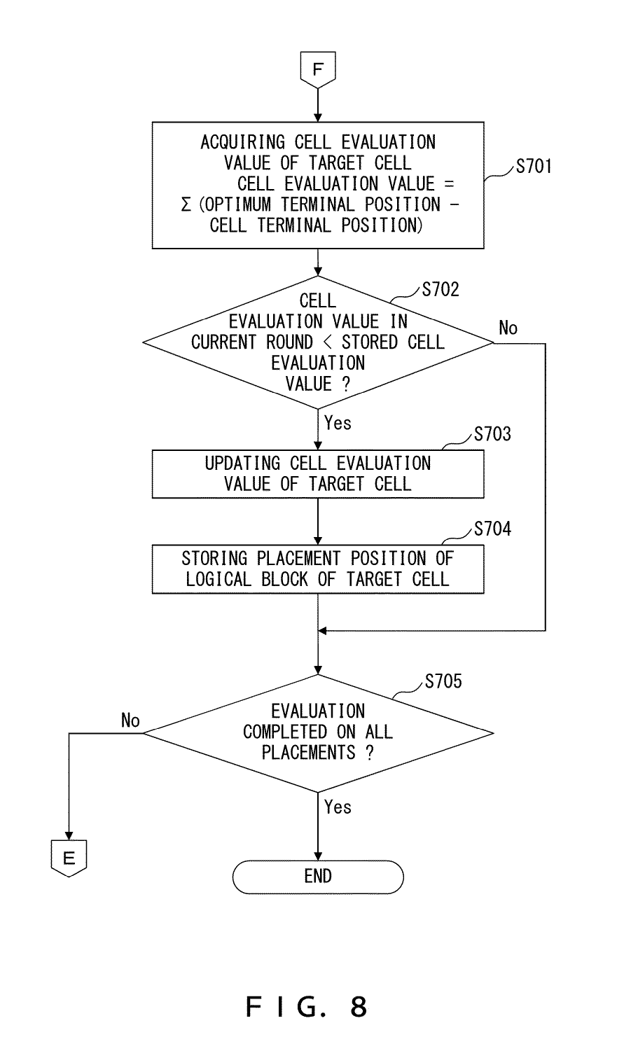

The process of selecting the placement order of logical blocks is described below with reference to FIGS. 5 through 8. FIGS. 5 and 6 are flowcharts of the placing process of a logical block. FIG. 7 is a flowchart of a unit evaluation process of a logical block. FIG. 8 is a flowchart of an evaluating process of a cell.

The process is described with reference to FIG. 5.

The logic placement unit 15 acquires the circuit information about a reference cell corresponding to the target cell from the reference cell information 21 (S401).

Furthermore, the logic placement unit 15 acquires the optimum terminal position of the target cell from the optimum terminal information 23 (S402).

Then, the logic placement unit 15 obtains a terminal evaluation value of each cell terminal of the reference cell corresponding to the target cell (S403). The terminal evaluation value of the cell terminal of the reference cell may be, for example, the distance between the optimum terminal position of the target cell acquired in S402 and the placement position of the cell terminal of the reference cell. In this case, the smaller the terminal evaluation value of the cell terminal is, the shorter the distance between the optimum terminal position of the target cell and the position of the cell terminal of the reference cell becomes.

The logic placement unit 15 stores the terminal evaluation value of each cell terminal of the reference cell obtained in S403 in the storage unit 20 (S404).

Next, the logic placement unit 15 obtains the cell evaluation value of the reference cell corresponding to the target cell (S405). The cell evaluation value of the reference cell is, for example, the variation obtained by adding the terminal evaluation values of the respective cell terminals of the reference cell stored in the storage unit 20 in S404. In this case, the smaller the cell evaluation value of the reference cell is, the shorter the average distance between the optimum terminal position of the target cell and the position of the cell terminal of the reference cell becomes.

The logic placement unit 15 stores the cell evaluation value of the reference cell in the storage unit (S406).

The logic placement unit 15 acquires from the logical block information 26 the type of logical block of the target cell, the identification information, and the placement position of the cell terminal in the logical block (S407).

Furthermore, the logic placement unit 15 acquires the connection rule of the target cell from the connection rule information 28 (S408).

Then, the logic placement unit 15 selects a logical block which has not been replaced in the target cell (S409).

The process is described with reference to FIG. 6.

The logic placement unit 15 selects an unplaced segmented area in which logical blocks have not been placed (S501).

In this case, when the logic placement unit 15 refers to the connection rule acquired in FIG. 408, and places a logical block in the segmented area selected in S501, it judges whether or not the placement order of the logical block is determined according to the connection rule (S502). When the placement order of the logical block is different from the connection rule (NO in S502), the logic placement unit 15 performs the process in S501.

When the placement order is based on the connection rule (YES in S502), the logic placement unit 15 judges whether or not the logical block is flipped (left-to-right reverse) and placed (S503). The logic placement unit 15 may select the left-to-right reverse placement of a logical block so that all combinations are generated in combining the placement order of a logical block and the left-to-right reverse placement of a logical block. When the logic placement unit 15 places logical blocks in the same segmented area, the logical blocks placed in the left-to-right reverse array may be placed in the segmented area.

When the logic placement unit 15 judges that the logical blocks are to be flipped (YES in S503), it places the logical blocks in the left-to-right reverse array, and places them in the segmented area selected in S501 (S504).

When the logic placement unit 15 judges that the logical blocks are not to be flipped (NO in S503), it does not place the logical blocks in the left-to-right reverse array, but places them as is in the selected segmented area (S505).

The process is described below with reference to FIG. 7.

The logic placement unit 15 judges whether or not there is a cell terminal in the placed logical blocks (S601). When there is no cell terminal in the placed logical blocks (NO in S601), the logic placement unit 15 performs the process in S605 described later.

When there is a cell terminal in the placed logical blocks (YES in S601), the logic placement unit 15 obtains a terminal evaluation value of the target cell (S602). When the terminal evaluation value of the target cell is obtained, for example, the distance from the placement position of the cell terminal of the logical block placed in the target cell is obtained from the optimum terminal position of the target cell acquired in S402. In this case, the smaller the terminal evaluation value of the target cell is, the shorter the distance between the optimum terminal position of the target cell and the position of the cell terminal of the logical block placed in the target cell becomes. When the logical block has a plurality of cell terminals, the terminal evaluation value of each cell terminal may be obtained.

Then, the logic placement unit 15 judges whether or not the terminal evaluation value of the cell terminal of the target cell obtained in S602 is smaller than the terminal evaluation value of the corresponding cell terminal assigned to the reference cell corresponding to the target cell (S603). When the logical block has a plurality of cell terminals, it may be judged whether or not the total value of the terminal evaluation value of each cell terminal is smaller than the total value of the terminal evaluation value of the corresponding cell terminal assigned to the reference cell corresponding to the target cell.

When the terminal evaluation value of the cell terminal of the target cell is not less than the terminal evaluation value of the cell terminal of the reference cell (NO in S603), the placement of a logical block is released (S604), the process in S501 is performed. Thus, in the replacement of the logical block in the target cell, the logic placement unit logic placement unit 15 may prevent the cell terminal of the target cell from being located farther from the optimum terminal position than the cell terminal of the reference cell.

When the terminal evaluation value of the cell terminal of the target cell is smaller than the terminal evaluation value of the cell terminal of the reference cell (YES in S603), the logic placement unit 15 determines that the logical block is to be placed in the selected segmented area (S605). Thus, in the replacement of the logical block in the target cell, the logic placement unit 15 may allow the cell terminal of the target cell to be closer to the optimum terminal position than the cell terminal of the reference cell.

The logic placement unit 15 stores the terminal evaluation value of the cell terminal of the target cell obtained in S602 in the storage unit 20 (S606). Thus, if all logical blocks of the target cell have been placed, the logic placement unit 15 stores the terminal evaluation values of all cell terminals of the target cell in the storage unit 20.

The logic placement unit 15 judges whether or not all logical blocks have been placed (S607). If all logical blocks have not been placed (NO in S607), the logic placement unit 15 performs the process in S409, thereby performing the process of placing other logical blocks.

The process is described below with reference to FIG. 8.

If all logical blocks have been placed (YES in S606), the logic placement unit 15 obtains the cell evaluation value of the target cell (S701). The cell evaluation value of the target cell may be, for example, the total value of the terminal evaluation values of the cell terminals of the target cell stored in the storage unit 20 in S606. In this case, the smaller the cell evaluation value of the target cell is, the shorter the average distance between the optimum terminal position of the target cell and the position of the cell terminal of the target cell becomes.

The logic placement unit 15 judges whether or not the cell evaluation value obtained in S701 is smaller than the cell evaluation value stored in the storage unit 20 (S702). The stored cell evaluation value may be, for example, the cell evaluation indicating the smallest value in the cell evaluation values obtained in S701 in the previous processes. In addition, the initial value of the stored cell evaluation value may be, for example, the cell evaluation value of the reference cell stored in the storage unit 20 in S406.

If the cell evaluation value obtained in S701 is not less than the cell evaluation value stored in the storage unit (NO in S702), the logic placement unit 15 performs the process in S705 described later.

If the cell evaluation value obtained in S701 is less than the cell evaluation value stored in the storage unit 20 (YES in S702), the logic placement unit 15 updates the cell evaluation value of the target cell (S703). In this case, the logic placement unit 15 may overwrite the cell evaluation value obtained in S701 with the cell evaluation value obtained in S701.

The logic placement unit 15 also stores the placement position of the logical block of the target cell determined in S605 in the placement cell information 24 (S704). In this case, the logic placement unit 15 may overwrite the placement position of the logical block of the target cell stored in the placement cell information 24 with the placement position of the logical block determined in S605.

The logic placement unit 15 judges whether or not the unit evaluation process of the logical block in S601 through S607 or the cell evaluation process in S701 through S704 has been performed on all combinations of the placement orders of the logical blocks in a cell (S705).

When the unit evaluation process of the logical block or the cell evaluation process has not been completed on all combinations of the placement orders of the logical blocks in a cell (NO in S705), the logic placement unit 15 performs the process in S409, and evaluates the placement order of other logical blocks.

When the unit evaluation process of the logical block or the cell evaluation process has been completed on all combinations of the placement orders of the logical blocks in a cell (YES in S705), the logic placement unit 15 terminates the process of selecting the placement order of the logical block. The placement order of the last logical block stored in the placement cell information 24 in S704 is the placement order of the logical block which makes the shortest possible wiring in the cell in accordance with the connection rule.

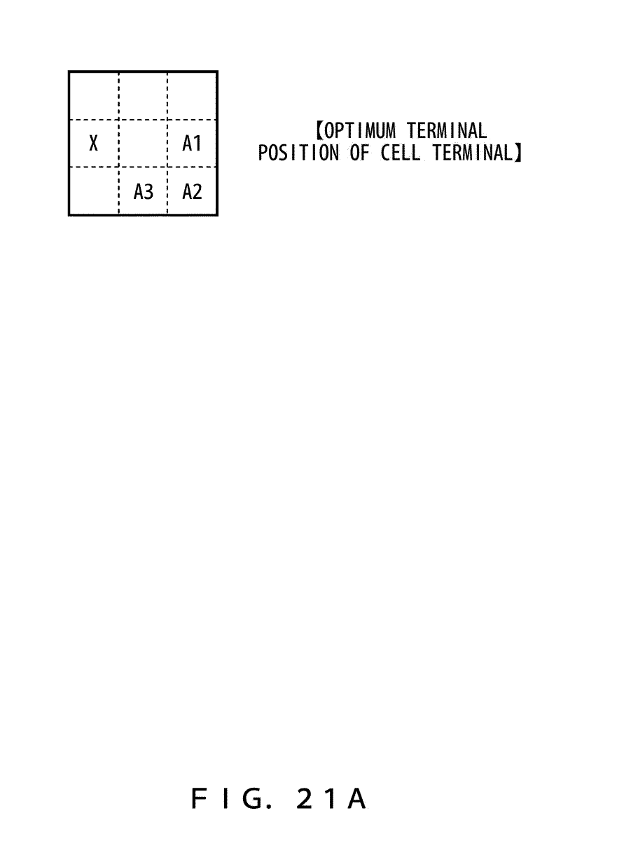

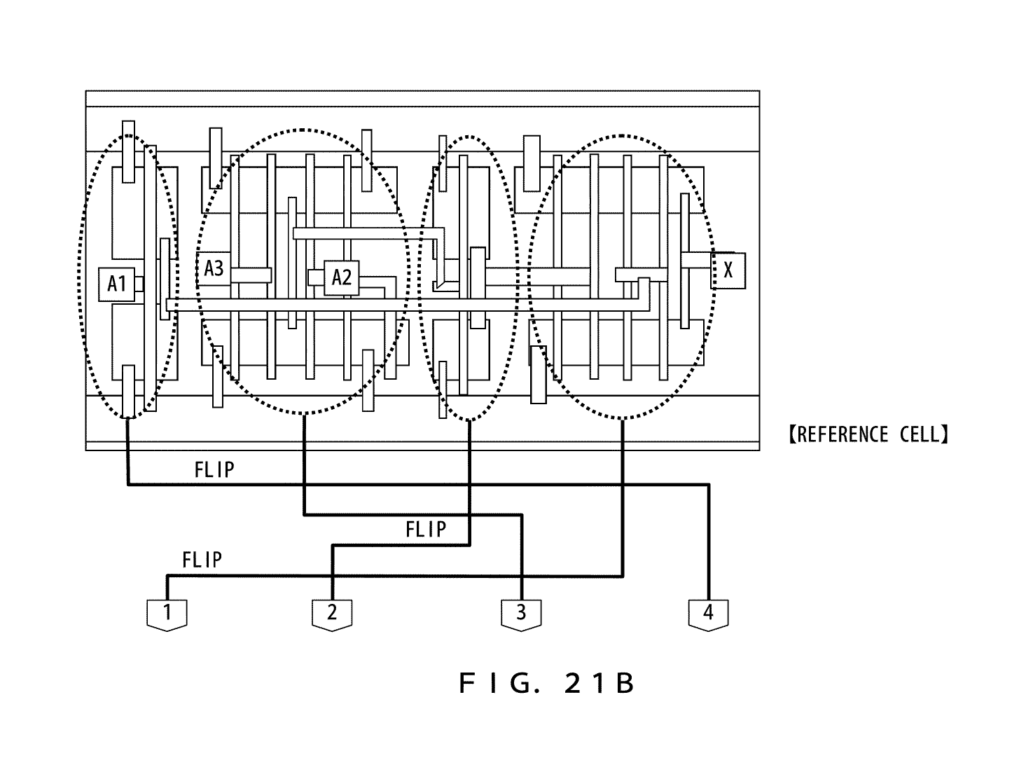

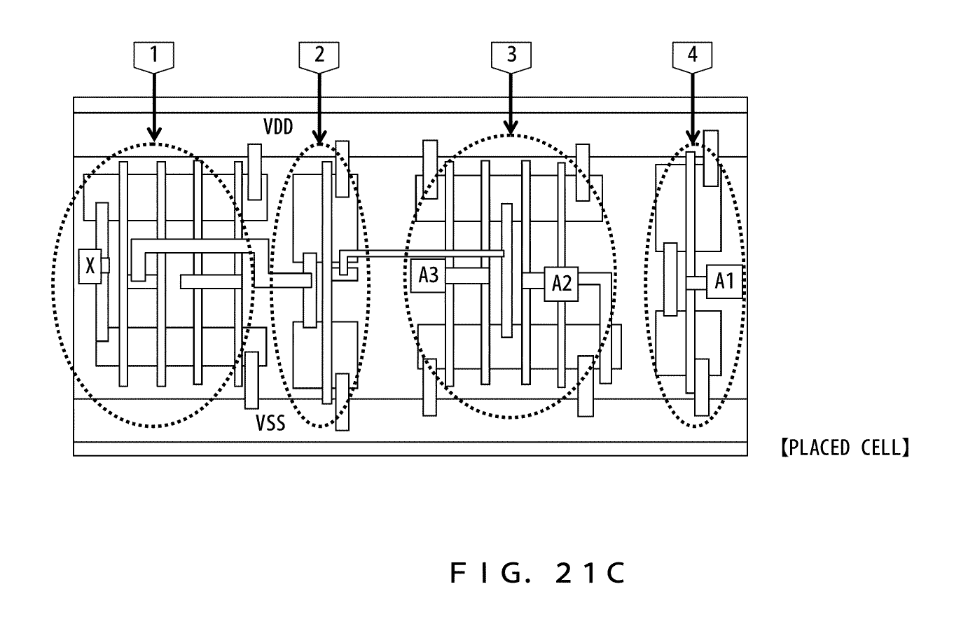

As described above, as illustrated in FIG. 21A, FIG. 21B, and FIG. 21C, when the optimum position of the cell terminal is set, the logic placement unit 15 generates an placed cell obtained by replacing the logical block of the reference cell so that each cell terminal may approach the optimum position.

The process is described with reference to FIG. 2.

The logic placement unit 15 registers in the placement cell information 24 the placement order of the last logical block stored in S704 in the placement cell information 24 as the placed cell obtained by replacing the logical block of the reference cell (S110). Then, the logic placement unit 15 performs the process in S106.

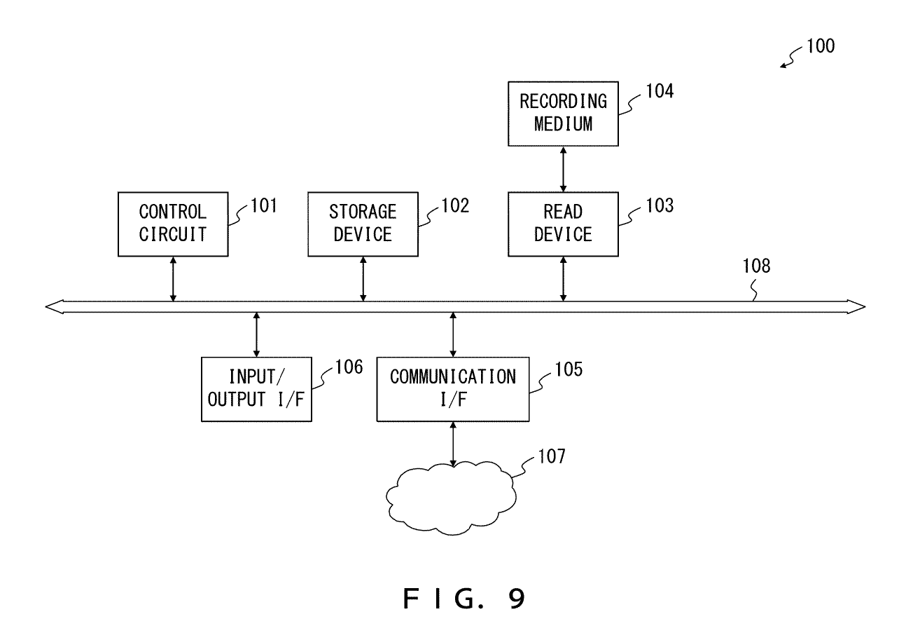

FIG. 9 is a block diagram of an embodiment of a computer device.

The configuration of the design support device 1 is described below with reference to FIG. 9.

In FIG. 9, a computer device 100 includes a control circuit 101, a storage device 102, a read device 103, a recording medium 104, a communication interface 105 (communication I/F), an input/output interface 106 (input/output I/F), and a network 107. Each component is connected through a bus 108.

The control circuit 101 controls the entire computer device 100. Then, the control circuit 101 is, for example, a CPU, a multi-core CPU, an FPGA (field programmable gate array), and a PLD (programmable logic device), etc. The control circuit 101 functions as, for example, the control unit 10 illustrated in FIG. 1. The terminal evaluation value and the cell evaluation value may be stored in the cache of, for example, the CPU, the FPGA, and the PLD.

The storage device 102 stores various types of data. The storage device 102 is configured by, for example, memory such as ROM (read only memory), RAM (random access memory), etc., and an HD (hard disk) etc. The storage device 102 functions as, for example, the storage unit 20 illustrated in FIG. 1. Then, the storage device 102 stores, for example, the reference cell information 21, the cell position information 22, the optimum terminal information 23, the placement cell information 24, the cell connection information 25, the logical block information 26, the cell logic information 27, and the connection rule information 28.

Furthermore, the ROM stores a program such as a boot program etc. The RAM is used as a work area of the control circuit 101. The HD stores a program such as the OS, an application program, firmware, etc., and various types of data.

The storage device 102 stores a design support program used to direct the control circuit 101 as the control unit 10.

When the placement process in a cell is performed, the design support device 1 reads a design support program stored in the storage device 102 to the RAM. Thus, the design support program read to the RAM is executed by the control circuit 101, and the design support device 1 performs the placing process in the cell.

The design support program may be stored in the storage device of the server on the network 107 if the control circuit 101 may be accessible through the communication interface 105.

The read device 103 is controlled by the control circuit 101, and reads and writes data in the removable recording medium 104. Then, the read device 103 is, for example, an FDD (floppy disk drive), a CDD (compact disc drive), a DVDD (digital versatile disk drive), a BDD (Blu-ray disk drive (registered trademark)), a USB (universal serial bus), etc.

The recording medium 104 stores various types of data.

The recording medium 104 stores, for example, a design support program. Furthermore, the recording medium 104 may store the reference cell information 21, the cell position information 22, the optimum terminal information 23, the placement cell information 24, the cell connection information 25, the logical block information 26, the cell logic information 27, and the connection rule information 28 illustrated in FIG. 1.

The recording medium 104 is connected to the bus 108 through the read device 103, and the control circuit 101 controls the read device 103, thereby reading and writing data. In addition, the recording medium 104 is, for example, an FD (floppy disk), a CD (compact disc), a DVD (digital versatile disk), a BD (Blu-ray disk (registered trademark)), and flash memory, etc.

The communication interface 105 connects for communication the computer device 100 with other devices.

The input/output interface 106 is connected to, for example, a keyboard, a mouse, a touch panel, etc., and when a signal indicating various types of information is input from a connected device, it outputs the signal input through the bus 108 to the control circuit 101. When the signal indicating various types of information output from the control circuit 101 is input through the bus 108, the input/output interface 106 outputs the signal to the various types of connected devices. The input/output interface 106 accepts input such as the placement position information about a cell placed in the integrated circuit from a user, the function information about an integrated circuit, etc.

The network 107 is, for example, a LAN, a wireless communication, the Internet, etc., and connects for communication between the computer device 100 and other devices.

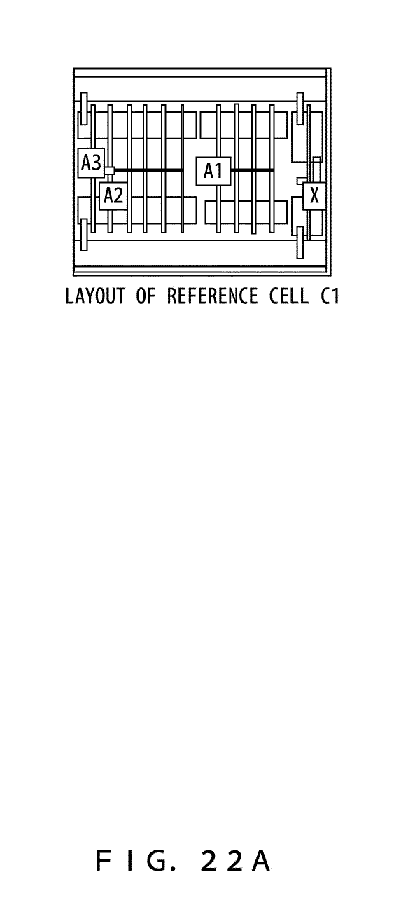

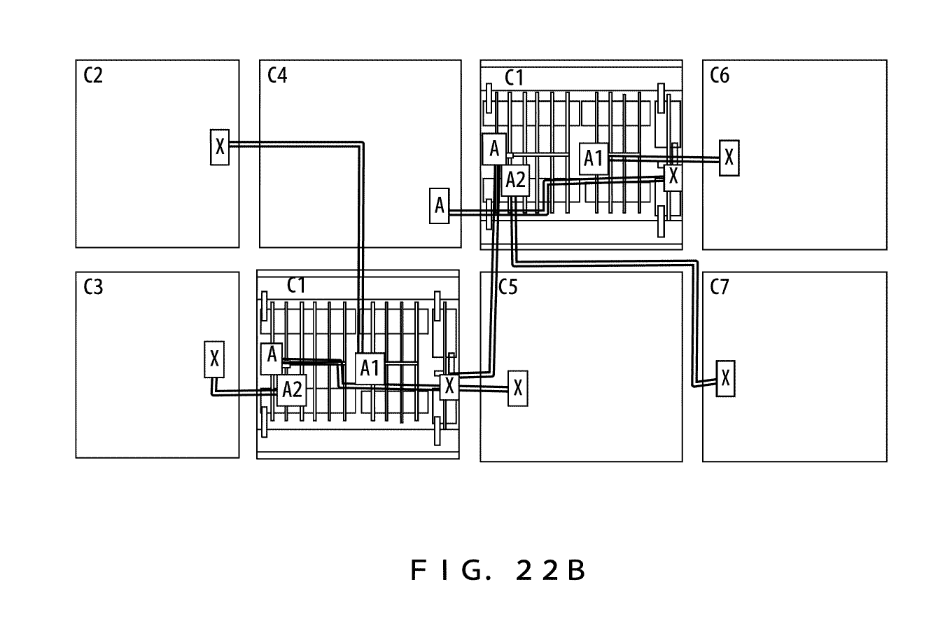

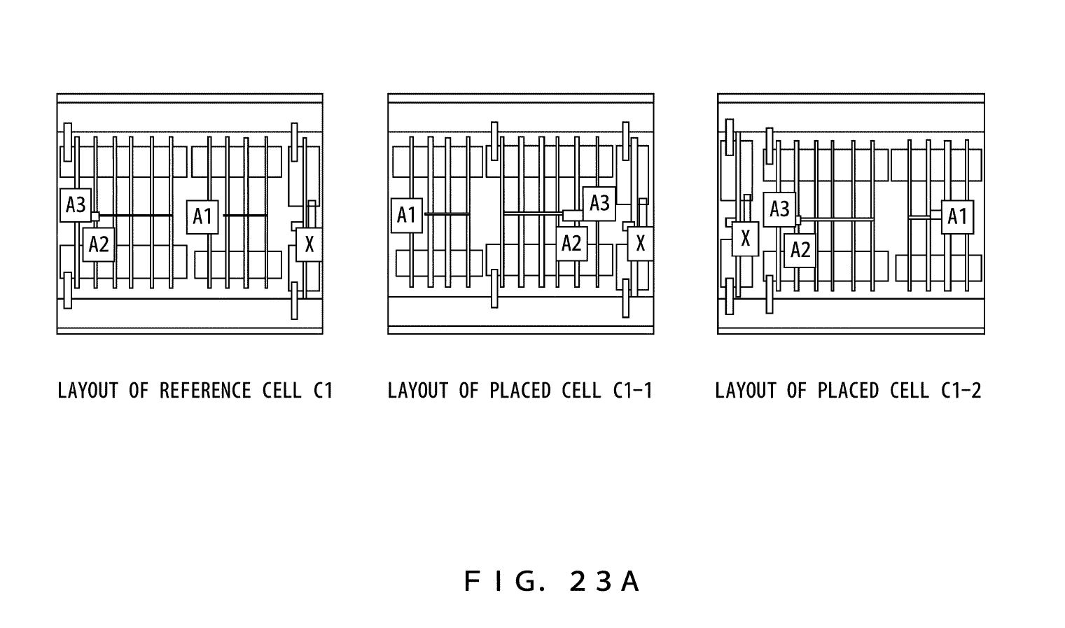

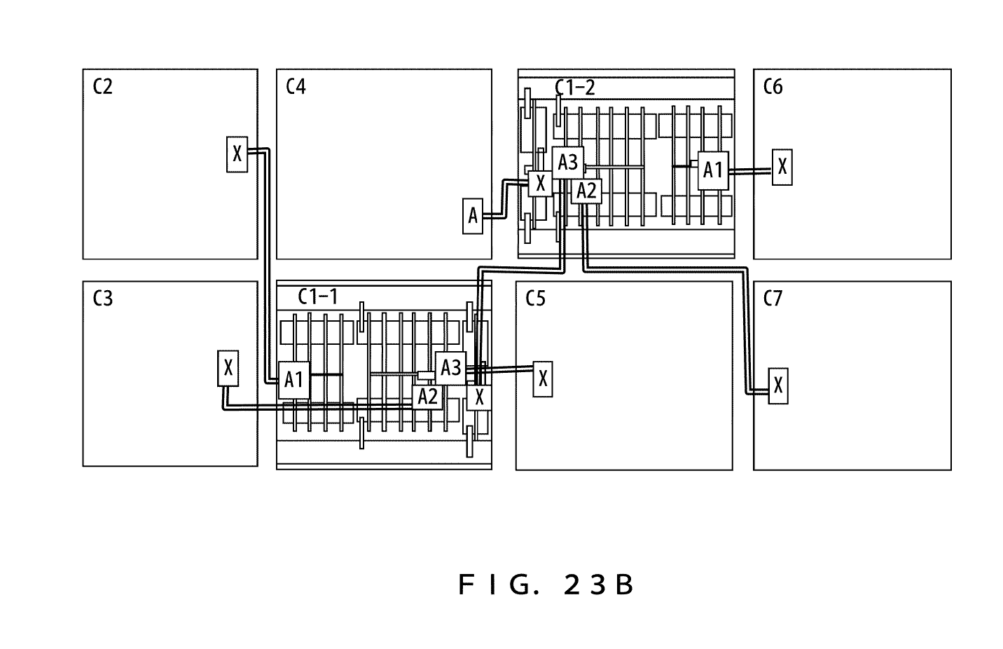

As described above, the design support device 1 according to an embodiment of the present invention places a reference cell on an integrated circuit, and then replaces the logical block in the cell so that the wiring in the cell may be shorter. Thus, the design support device 1 makes the wiring shorter between the cells as the wiring between the transistor of the first cell and the transistor of the second cell, and reduces the influence on the input/output timing of various signals. For example, as with the prior art, when the reference cell C1 is placed as is on an integrated circuit, the wiring in each cell is placed as illustrated in FIG. 22A and FIG. 22B. On the other hand, the design support device 1 according to the embodiment of the present invention, the reference cell C1 is replaced into the placed cell C1-1 and the placed cell C1-2, and placed on an integrated circuit. Therefore, the wiring in each cell may be shorter as illustrated in FIG. 23A and FIG. 23B, and the inter-cell wiring may be shorter.

Furthermore, the design support device 1 according to the embodiment of the present invention stores an placed cell which is a replaced cell, and when it places the same cell in type and optimum position of the cell terminal connected to another cell, the device uses the placed cell stored. Thus, the design support device 1 according to the embodiment of the present invention may avoid the process of generating an placed cell of the same configuration.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A design support device, comprising
a processor which performs processes of:
determining an optimum position of a first terminal of a first cell as a first position in which an inter-terminal wiring between the first cell and a second cell connected to the first cell through the first terminal is short;
extracting one or more logical blocks including a logical block having the first terminal from the first cell; and
placing one or more logical blocks so that the first terminal may become close to the first position.

2. The device according to claim 1, wherein the processes performed by the processor further comprises:
retrieving two or more mutually connected logical blocks from among two or more logical blocks when a logic extraction unit extracts the two or more logical blocks from the first cell;
setting respective placement orders of the two or more connected logical blocks so that each output destination of each connected logical block on an output side may be in a same direction in the two or more connected logical blocks; and
defining a placement of the two or more connected logical blocks as the set placement order when the two or more logical blocks are placed, and placing the two or more logical blocks so that the first terminal may become close to the first position.

3. The device according to claim 1, wherein the processes performed by the processor further comprises
extracting an area in which diffusion layers of the first cell are continuously placed as the one or more logical blocks.

4. The device according to claim 1, wherein the processes performed by the processor further comprises
determining the first position by averaging an influence of input signal timing against connected plurality cells when there are plurality cells which are connected to the first terminal.

5. The device according to claim 1, wherein the processes performed by the processor further comprises
obtaining a distance between the first terminal and the first position each time a placement of the one or more logical blocks is changed, and placing the one or more logical blocks for the placement with the shortest distance.

6. The device according to claim 1, wherein:
the first cell further comprises a second terminal connected to a third cell; and
the processes performed by the processor further comprises;
determining the optimum position of the second terminal as a second position in which a wiring length between the first cell and the third cell is short; and
placing the one or more logical blocks so that the second terminal may become close to the second position.

7. The device according to claim 6, wherein the processes performed by the processor further comprises
obtaining a total distance which is calculated to add a distance between the first terminal and the first position to a distance between the second terminal and the second position, and placing the one or more logical blocks so that the total distance may become minimized.

8. The device according to claim 1, further comprising
a storage unit which stores a placement of one or more logical blocks of the first cell, the placement being performed in a process of placing the logical blocks, wherein
the processes performed by the processor further comprises
when there is a third cell which is identical with the first cell in type and in which an optimum position of a terminal connected to another cell is set in a position corresponding to the first position, making a placement of one or more logical blocks of the third cell be identical with a placement of one or more logical blocks of the first cell.

9. The device according to claim 1, wherein
the processes performed by the processor further comprises
changing placement position of the one or more logical blocks and left-to-right reverse array of the one or more logical blocks, and placing the one or logical blocks so that the first terminal may become close to the first position.

10. An information processing method performed by a computer, the method comprising:
determining an optimum position of a first terminal of a first cell as a first position in which an inter-terminal wiring between the first cell and a second cell connected to the first cell through the first terminal is short;
extracting one or more logical blocks including a logical block having the first terminal from the first cell; and
placing one or more logical blocks so that the first terminal may become close to the first position.

11. The method according to claim 10 further comprises:
retrieving two or more mutually connected logical blocks from among the two or more logical blocks when two or more logical blocks are extracted from the first cell in the process of extracting one or more logical blocks from the first cell;
setting placement order of the two or more connected logical blocks so that an output destination of each connected logical block on an output signal side may be in an identical direction in the two or more connected and retrieved logical blocks; and
defining a placement of the two or more connected logical blocks as the set placement order in the process of setting a placement order when the two or more logical blocks are placing, and placing the two or more logical blocks so that the first terminal may become close to the first position.

12. A computer-readable recording medium which stores a program used by a computer to perform a process of designing a circuit, the process comprising:
determining an optimum position of a first terminal of a first cell as a first position in which an inter-terminal wiring between the first cell and a second cell connected to the first cell through the first terminal is short;
extracting one or more logical blocks including a logical block having the first terminal from the first cell; and
placing one or more logical blocks so that the first terminal may become close to the first position.

13. The recording medium according to claim 12, wherein the process further comprises:
retrieving two or more mutually connected logical blocks from among the two or more logical blocks when two or more logical blocks are extracted from the first cell in the process of extracting one or more logical blocks from the first cell;
setting placement order of the two or more connected logical blocks so that an output destination of each connected logical block on an output signal side may be in an identical direction in the two or more connected and retrieved logical blocks; and
defining a placement of the two or more connected logical blocks as the set placement order in the process of setting a placement order when the two or more logical blocks are placed, and placing the two or more logical blocks so that the first terminal may become close to the first position.
